(19) United States
(12) Patent Application Publication
(10) Pub. No.: US 2016/0186096 A1
(43) Pub. Date: Jun. 30, 2016

(54) LIQUID TREATING AND FINISHING PRODUCT FOR WASHING FABRIC ITEMS IN WATER, IN A WASHING MACHINE, AND METHOD FOR USING SAID PRODUCT IN SUCH A MACHINE

(71) Applicant: COBEL S.A. (SOCIÉTÉ ANONYME), Luxembourg (LU)

(72) Inventors: Christian Eberhardt, Strasbourg (FR); Patrick Launay, Geispolsheim (FR)

(73) Assignee: Cobel S.A., Luxembourg (LU)

(21) Appl. No.: 14/787,129

(22) PCT Filed: Apr. 25, 2014
(86) PCT No.: PCT/IB2014/001148

§ 371 Date: Mar. 15, 2016

(30) Foreign Application Priority Data
Apr. 26, 2013 (EP) 13305552.5

(51) Int. Cl. C11D 3/00; C11D 3/40; C11D 3/20

(52) U.S. Cl. CPC C11D 3/0015; C11D 3/2079; C11D 3/40

(57) ABSTRACT

The invention relates to a liquid treating and finishing product for washing fabric items in water, in a washing machine, especially items of clothing or household items. It consists of a mixture comprising at least one basic liquid treatment and finishing substance consisting of a white, alcohol vinegar or crystal vinegar and an additional odorous substance. The concentration of vinegar in the mixture is between 94 and 99.9 wt. % in relation to the total weight of the mixture and the concentration of the additional odorous substance in the mixture is between 0.1 and 6 wt. % in relation to the total weight of the mixture. The invention also relates to a method for using the product in the machine.

### TECHNICAL FIELD

The present invention relates to the area of washing fabric items, especially items of clothing or household items in water in washing machines, more particularly in the area of professional washing and cleaning, and has as its subject matter a product for the liquid treatment and finishing of fabric items for use as clothing or household items for the washing cycle with water in a washing machine. It also relates to a method for using the product in such a machine.

### BACKGROUND

It is known that there are different manners or methods of washing laundry with different apparatuses and/or products in the area of professional washing, namely, in launderettes, dry cleaners or laundries.

One of these known methods is that of traditional washing with water which uses washing machines and detergents based on detergent compositions. The washing cycle with water in these machines comprises in particular the following phases: the washing phase, generally using detergents, soaps or reinforcers, the rinsing phase, which can comprise one or several rinsings and the spin-drying phase.

However, with these machines the total washing cycle with water, then of drying (with a temperature generally below 40° C.), which generally takes between 60 and 90 minutes, is long and requires an elevated consumption of water. Furthermore, it has frequently been determined that the laundry, according to the material or the texture of the fabric of the laundry, shrinks, loses its color, becomes wrinkled or sees its content altered.

Another method is that of dry-cleaning, more respectful of the fabrics, which uses a machine operating in a closed circuit with a solvent instead of water such as perchloroethylene.

However, in this process of dry-cleaning, if the solvent has a strong cleaning, degreasing power without the addition of detergent, and allows the preservation of the fabrics while preserving their content or for their colors, the solvent is not evacuated from the machine like detergents but evaporates upon the opening of the door, causing inhalations of the operator which are dangerous for his health, in particular in the case of inhaling vapors coming from a solvent of the perchloroethylene type.

In order to solve this problem of the evaporation of solvents such as perchloroethylene used in dry-cleaning the machines are placed, according to the requirements of the standards in place (in particular the standard known under the reference number “2345”) in isolated locations and provided with ventilations, which generates significant supplementary expenses. Moreover, the evacuation of the evaporation of the solvent sometimes extends to other commercial locations as is the case in particular in commercial centers in which the stores communicate with each other through aeration or ventilation conduits. Finally, due to the elevated risk of allergies, irritations or cancers caused by the inhalation of organic, volatile, harmful compounds in spite of the current solutions of evacuation, certain solvents which are used the most like perchloroethylene are considered today as carcinogenic and will no longer be allowed in the years to come.

In order to remedy these disadvantages, the manufacturers have developed new products for dry-cleaning of which some are based on silicone, less volatile and less toxic that the preciously cited traditional solvents such as perchloroethylene used in traditional dry-cleaners. However, these new products have a cleaning efficiency less than 50%, that is, only one half of the dirt or dust is eliminated from the laundry or the garment after the cleaning. Furthermore, if these new products are more ecological than the current products, they remain poorly volatile and do not completely avoid the harmful inhalations so that they also risk being prohibited in the future. On the other hand, these new products leave disagreeable odors on the garments. Finally, the time of a complete washing and drying cycle with these new products (approximately 75 minutes) remains too high.

Moreover, several problems at the level of the results of the washing with water or of dry-cleaning were determined for the current, previously cited products for washing with water or for dry-cleaning, namely, on the one hand problems of wrinkling, in particular of linings which consist of artificial fibers (acetate/viscose) and of fabrics of wool or a mixture and, and on the other hand problems of puckering, that is, seam threads which become shorter or shrink during the washing with water and cause undulations on the fabrics necessitating a long and stressful redoing in order to eliminate them.

### SUMMARY

The present invention has the problem of alleviating these disadvantages by proposing a liquid treatment and finishing product for the washing cycle with water in a machine for washing in water items of clothing or household items that is 100% ecological, non-volatile and non-toxic, avoiding in particular the problems of wrinkling, deformation, and undulation of fabrics coated with the current products while noticeably reducing the time for the washing and drying of the item under consideration and ensuring a high degree of protection of the fibers constituting these fabrics and of their colors.

A liquid product is provided for the treatment and finishing of fabric items, in particular items of clothing or household items for being washed in water in a washing machine, the liquid product constituted by a mixture comprising at least, on the one hand, a liquid base substance for the treatment and finishing consisting of at least one of an alcohol vinegar, a white vinegar, and a crystal vinegar and on the other hand an additional odorous substance, wherein the concentration of the liquid base substance in the mixture is comprised between 94 and 99.9% by weight relative to the total weight of the mixture and the concentration of the additional odorous substance in the mixture is comprised between 0.1 and 6% by weight relative to the total weight of the mixture.

A method for using the treatment and finishing product for washing fabric items, especially clothing items or household items with water in a washing machine, is also provided wherein the washing machine comprises a washing cycle including at least the three following phases: a washing phase using at least one detergent or a soap or another detergent, a rinsing phase comprising a rinsing cycle or a succession of several rinsing cycles and a spin-drying phase, wherein the treatment and finishing product is added into the rinsing cycle or into one of the rinsing cycles.

### BRIEF DESCRIPTION OF THE DRAWINGS

FIG. 1 shows a table with an evaluation of the results of the washing cycle of a current washing machine, using the treatment and finishing product in accordance with the present invention.

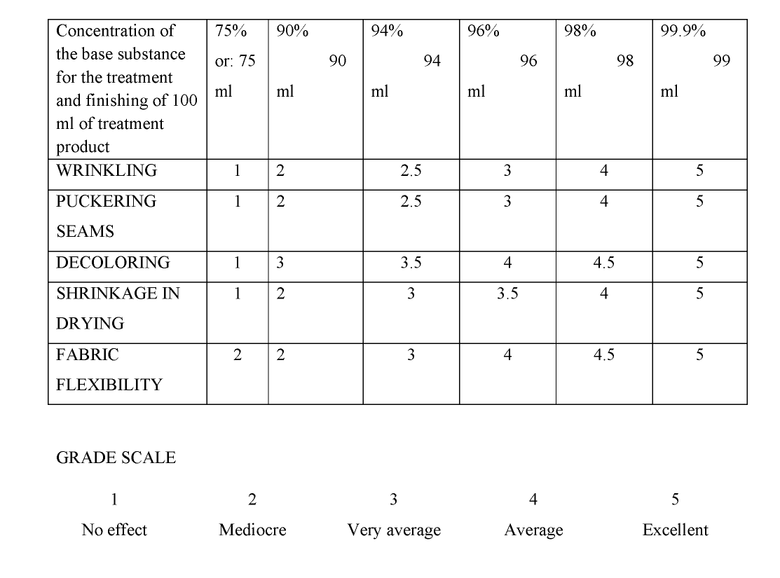

### DETAILED DESCRIPTION

The present disclosure provides a liquid product for the treatment and finishing of fabric items, in particular items of clothing or household items in the water cycle with water in a washing machine, characterized substantially in that it is constituted by a mixture comprising at least, on the one hand, a liquid base substance for the treatment and finishing consisting of alcohol vinegar or of white vinegar or crystal vinegar and on the other hand an additional odorous substance, and that the concentration of this base substance in the mixture is comprised between 94 and 99.9% by weight relative to the total weight of the mixture and that the concentration of the additional odorous substance in the mixture is comprised between 0.1 and 6% by weight relative to the total weight of the mixture.

The base substance for treatment and finishing can comprise 3 to 14% of acetic acid, preferably 6 to 14% of acetic acid and more preferably 6 to 8% of acetic acid by weight relative to the total weight of the base substance for treatment and finishing.

More particularly, the base substance for treatment and finishing can comprise a mixture of water and acetic acid, preferably with a concentration of acetic acid by weight relative to the total weight of the base substance for treatment and finishing comprised in the ranges cited in the previous paragraph.

The additional odorous substance allows the disagreeable odor of the vinegar to be neutralized and confers an odor of freshness and cleanness to the fabric coming from the washed and dried item.

In a preferred embodiment of the concentration of the base substance for treatment and finishing in the mixture it can be comprised between 98 and 99.9%, preferably between 99 and 99.9% and more preferably between 99.7 and 99.9% by weight relative to the total weight of the mixture.

The additional odorous substance can preferably consist of essential oil.

The mixture can furthermore comprise an additional coloring substance and the concentration of the latter in the mixture can be comprised between 0.1 and 2%, more preferably between 0.1 and 0.5% by weight relative to the total weight of the mixture.

The additional coloring substance can consist of a natural pigment of mineral or organic or synthetic origin.

Such an additional coloring substance can consist of a natural pigment with a mineral or organic or synthetic origin. A pigment of mineral origin can be, for example, of mineral pigment oxide blue or another color.

In a preferred embodiment of the mixture achieving exceptional results it can comprise a concentration of base substance for treatment and finishing comprised approximately between 99.5 and 99.7%, preferably approximately equal to 99.7%, by weight relative to the total weight of the mixture, a concentration of additional odorous substance approximately comprised between 0.2 and 0.4%, preferably approximately equal to 0.2% by weight relative to the total weight of the mixture, and a concentration of additional coloring substance approximately comprised between 0.1 and 0.3%, preferably approximately equal to 0.1% by weight relative to the total weight of the mixture.

The present invention also has as subject matter a method for using the treatment and finishing product defined according to the present invention for washing fabric items, especially clothing items or household items with water in a washing machine, the washing machine comprising a washing cycle including at least one detergent or a soap, a rinsing phase comprising a rinsing cycle or a succession of several rinsing cycles and a spin-drying phase, characterized in that it consists of adding this treatment and finishing product into the rinsing cycle or into one of the rinsing cycles.

In a preferred embodiment the rinsing phase comprises a succession of several rinsing cycles ending in the last rinsing cycle and the method consists in adding the treatment and finishing product into the last rinsing cycle.

The attached drawing shows a table indicating by way of example and after trials carried out by the present applicant an evaluation of the results of the washing cycle of a current washing machine, for example, a washing machine sold by the Eberhardt Freres under the name “IPSO” and with the reference number, for example, “HD135” or “HD195” or “HD235” or “HD305”, using the treatment and finishing product in accordance with the present invention used, for example, in a quantity of 100 ml in the cycle or the last rinsing cycle of this machine and in accordance with different concentrations of the base substance for treatment and finishing.

Such a current washing machine using water, for example of the type of the previously cited ones, provided for receiving the product according to the present invention can comprise in a known manner a washing cycle including at least one detergent or a soap or other solid, powdery or liquid detergent, a rinsing phase comprising a rinsing cycle or a succession of several rinsing cycles and a spin-drying phase.

It can be seen more particularly in this table that the evaluation of these results is made according to a scale of grades from 0 to 5.

For each concentration selected in this table the five results, grades from 0 to 5, concern the wrinkling, puckering of the seams (especially for suits), the decoloring, the shrinkage in the drying and the flexibility of the fabric constituting the item.

The term shrinkage denotes a retraction of the fibers or of the weaves.

Therefore, it is estimated by the present applicant that a grade of 2.5 to 5 allows the following satisfactory, even exceptional results to be obtained (notes ranging from 4 to 5): on the one hand a great limitation, even elimination of the wrinkling and of the seams (in particular for clothing items and suits) and on the other hand great flexibility of the fabric washed without shrinkage or deformation during drying.

It can be seen more particularly that the selection of the range of 94 to 99.9% for the concentration of the base substance for treatment and finishing in the mixture constituting the product according to the present invention is made with the goal of obtaining the satisfactory, even exceptional results indicated above.

At values lower than those of the range selected according to the invention extending from 94 to 99.9%, it can be determined that with a concentration of the base substance for treatment and finishing approximately equal to 75%, the results obtain substantially the grade of 1 (mediocre) and for the flexibility of the fabric the grade of 2 (passable) and that with the concentration of the base substance for treatment and finishing equal to 90% the results obtain substantially the grade of 2 and for the decoloration the grade of 3 (very average).

The satisfactory, even exceptional results are made possible due to the effects obtained by the base finishing substance in its concentration comprised in the selected range running from 94 to 99.9%, namely, a stabilizing effect that prevents the water from stagnating or remaining on the fibers, which consequently remain a minimum time in contact with the water without being impregnated by it, especially for very hydrophilic wool fibers, which avoids their deformation and/or their retraction during drying and therefore the wrinkling of the item concerned. This stabilizing effect of the fibers therefore avoids their deterioration during the washing (elimination or great limiting of the deformation of the fibers) and during the drying (elimination or great limiting of the shrinking or retreat of the fibers).

These effects, which cannot be obtained, at least in a satisfactory manner, in the ranges of concentration of the base substance for treatment and finishing lower than about 94%, leave, after the washing of the fabric, especially of an item of clothing or of laundry and before their drying, fabrics which are not wrinkled, slightly moist, and depending on the case, without puckering of the seams (especially of the seams of suits). Such effects also allow the drying cycle to be accelerated (application 10 to 20 minutes, according to the temperature and the type of fibers compared to 30 to 45 minutes with the current products used in washing with water or in dry-cleaning) and therefore the ironing of the fabrics.

Therefore, the present invention allows a product to be offered that can be used in a classic washing machine and the obtention of the previously cited exceptional results with a very short washing and drying cycle (cycle) of approximately 30 to 45 minutes, much lower than the complete cycling times of washing or of dry-cleaning and of drying (greater than 45 minutes) achieved with the current products and/or machines. Such a product also allows the washing machines to be loaded at 70% instead of 50% with the current machines and allows a professional, for example a dry-cleaner to invest in a machine of 13 or 16 kg by virtue of a greater loading and the very short cycles.

Furthermore, the sorting of the clothing items is less demanding and does not require, contrary to the current methods, sorting the fabrics according to the artificial fibers or natural fibers but simply separating the heavy items, for example the coats from the light items, for example, the shirts or scarfs.

On the other hand it allows, especially with a concentration of the base substance for treatment and finishing that is noticeably greater than 98%, the acid colorants of wool, silk or other fibers of the acidic type to continue their migration on the fiber rather than to drop (run), which allows only the items with a red color to be sorted. In the case in which the dyeing has not been concluded, the action of the vinegar forming the base substance for treatment and finishing according to the present invention finishes the migration of the colorant on the fiber and the result is vivid and brilliant colors.

Furthermore, the product according to the present invention, which is 100% ecological (does not have toxic or harmful effects) allows the operator to work completely safely without destroying the items in particular during drying. Finally, the product is biodegradable. The product according to the present invention also has the advantage of being natural and being able to wash in water 99% of fabric items such as, in particular, clothing of wool or other articles made from other fragile fibers.

Of course, the invention is not limited to the embodiment described and shown in the attached drawings. Modifications remain possible, especially as regards the constitution of the various elements or by the substitution of technological equivalents without departing from the protective scope of the invention.

1. A liquid product for treatment and finishing of a fabric item being washed in water in a washing machine, the liquid product comprising:
a mixture comprising a liquid base substance including:
at least one of an alcohol vinegar, a white vinegar or a crystal vinegar and
an odorous substance,
wherein a concentration of the liquid base substance in the mixture is between 94% and 99.9% by weight relative to a total weight of the mixture, and
wherein a concentration of the odorous substance in the mixture is between 0.1% and 6% by weight relative to the total weight of the mixture.

2. The liquid product according to claim 1, wherein the liquid base substance includes 3% to 14% of acetic acid by weight relative to a total weight of the liquid base substance.

3. The liquid product according to claim 1, wherein the concentration of the liquid base substance in the mixture is between 98% and 99.9% by weight relative to the total weight of the mixture.

4. The liquid product according to claim 3, wherein the odorous substance includes essential oil.

5. The liquid product according to claim 1, wherein the mixture further comprises a coloring substance and the concentration of the coloring substance is between 0.1% and 2% by weight relative to the total weight of the mixture.

6. The liquid product according to claim 5, wherein the coloring substance includes a natural pigment of a mineral, organic, or synthetic origin.

7. The liquid product according to claim 5, wherein the concentration of the liquid base substance is approximately between 99.5% and 99.7% by weight relative to the total weight of the mixture, the concentration of the odorous substance is approximately between 0.2% and 0.4% by weight relative to the total weight of the mixture, and the concentration of the coloring substance is approximately between 0.1% and 0.3% by weight relative to the total weight of the mixture.

8. A method for treatment and finishing of a fabric item with water in a washing machine, the method comprising:
washing the fabric item using at least one of a detergent or a soap;
rinsing the fabric item; and
spin-drying the fabric item,
wherein the rinsing comprises executing a rinsing cycle or a succession of several rinsing cycles and adding a liquid product to the washing machine during the rinsing cycle or during one of the succession of several rinsing cycles, the liquid product comprising a mixture of a liquid base substance including at least one of an alcohol vinegar, a white vinegar, or a crystal vinegar, and an odorous substance, a concentration of the liquid base substance in the mixture being between 94% and 99.9% by weight relative to a total weight of the mixture, and a concentration of the odorous substance in the mixture being between 0.1% and 6% by weight relative to the total weight of the mixture.

9. The method according to claim 8, wherein the rinsing comprises executing a succession of several rinsing cycles ending in a last rinsing cycle and adding the liquid product to the washing machine during the last rinsing cycle.

10. The liquid product according to claim 1, wherein the liquid base substance includes 6% to 14% of acetic acid by weight relative to a total weight of the liquid base substance.

11. The liquid product according to claim 1, wherein the liquid base substance includes 6% to 8% of acetic acid by weight relative to a total weight of the liquid base substance.

12. The liquid product according to claim 1, wherein the concentration of the liquid base substance in the mixture is between 99% and 99.9% by weight relative to the total weight of the mixture.

13. The liquid product according to claim 1, wherein the concentration of the liquid base substance in the mixture is comprised between 99.7 and 99.9% by weight relative to the total weight of the mixture.

14. The liquid product according to claim 1, wherein the mixture further comprises a coloring substance and a concentration of the coloring substance is between 0.1% and 0.5% by weight relative to the total weight of the mixture.

15. The liquid product according to claim 5, wherein the concentration of the liquid base substance is approximately equal to 99.7% by weight relative to the total weight of the mixture, the concentration of the odorous substance is approximately equal to 0.2% by weight relative to the total weight of the mixture, and a concentration of the coloring substance is approximately equal to 0.1% by weight relative to the total weight of the mixture.
